(19) United States
(12) Patent Application Publication
(10) Pub. No.: US 2025/0178299 A1
(43) Pub. Date: Jun. 5, 2025

(54) METHOD FOR MANUFACTURING DISPLAY DEVICE AND ELECTRONIC DEVICE INCLUDING THE DISPLAY DEVICE

(71) Applicant: Samsung Display Co., LTD., Yongin-si (KR)

(72) Inventor: JONGHWAN CHO, Yongin-si (KR)

(73) Assignee: Samsung Display Co., LTD., Yongin-si (KR)

(21) Appl. No.: 18/958,307

(22) Filed: Nov. 25, 2024

(30) Foreign Application Priority Data
Dec. 1, 2023 (KR) 10-2023-0172300

(51) Int. Cl. B29D 11/00; G02B 1/04; G02B 1/14; G06F 1/16

(52) U.S. Cl. CPC B29D 11/00788; B29D 11/00932; G02B 1/04; G02B 1/14; G06F 1/1652

(57) ABSTRACT

A method of manufacturing a display device includes forming a base layer on a lower protective film, forming a hard coating layer on the base layer, forming a refractive layer having a refractive index of less than or equal to about 1.4 on the hard coating layer, and cutting an upper protective film including the base layer, the hard coating layer, and the refractive layer and the lower protective film with a laser.

### CROSS-REFERENCE TO RELATED APPLICATION(S)

This application claims priority to and benefits of Korean Patent Application No. 10-2023-0172300 under 35 U.S.C. § 119, filed on Dec. 1, 2023, in the Korean Intellectual Property Office (KIPO), the entire content of which are incorporated herein by reference.

### BACKGROUND

### 1. Technical Field

The disclosure relates to a method for manufacturing a display device and an electronic device including the display device that provides visual information.

### 2. Description of the Related Art

The thin display device is implemented in the form of a touch screen panel and is used in various smart devices such as smartphones and tablet PCs as well as various wearable devices. These touch screen panel-based display devices have a window cover made of tempered glass on the display panel to protect the display panel from scratches or external shocks.

Optical films applied to window cover films of recently developed foldable displays and flexible displays require high mechanical strength to replace glass and should not leave marks even when maintained in a deformed state such as folding and bending. In addition, when users use foldable displays, attempts to increase visibility by minimizing the reflection of external light are continuing.

### SUMMARY

Embodiments provide a method for manufacturing a display device with improved display quality.

A method for manufacturing a display device according to an embodiment of the disclosure may include forming a base layer on a lower protective film, forming a hard coating layer on the base layer, forming a refractive layer having a refractive index of less than or equal to about 1.4 on the hard coating layer, and cutting an upper protective film including the base layer, the hard coating layer, and the refractive layer and the lower protective film with a laser.

In one embodiment, an output of an oscillator that irradiates the laser may be in a range of about 5 watts to about 100 watts.

In one embodiment, a wavelength of the laser may be in a range of about 5 um to about 15 um.

In one embodiment, a diameter of the laser may be in a range of about 0.05 mm to about 0.2 mm.

In one embodiment, the method may further include removing the lower protective film after the cutting of the upper protective film and the lower protective film with the laser.

In one embodiment, in the cutting of the upper protective film and the lower protective film with the laser, the upper protective film and the lower protective film may be disposed on a stage and moved, and a moving speed of the stage may be in a range of about 10 m/min to about 50 m/min.

In one embodiment, the lower protective film may include a plastic.

In one embodiment, a thickness of the lower protective film may be in a range of about 50 μm to about 150 um.

In one embodiment, in the cutting of the upper protective film and the lower protective film with the laser, the laser may cut about 10% or more and about 70% or less of a thickness of the lower protective film.

In one embodiment, the refractive layer may include an organic compound including a difluorocarbene (—CF2) and a trifluoromethyl group (—CF3).

In one embodiment, a molar ratio of the difluorocarbene to the trifluoromethyl group may be about 2:1.

In one embodiment, the organic compound may include dodecafluoroheptyl acrylate (DFHA) represented by Formula 1.

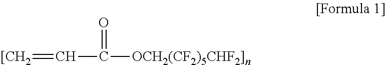

in Formula 1, n may be one of 6, 8, 10, and 12.

In one embodiment, in the forming of the refractive layer, the refractive layer may be formed by a vacuum deposition.

In one embodiment, the refractive layer may be a single layer.

In one embodiment, an elastic strain of the upper protective film may be in a range of about 7% to about 30%.

In one embodiment, a thickness of the refractive layer may be in a range of about 70 nm to about 130 nm.

In one embodiment, a thickness of the hard coating layer may be in a range of about 5 um to about 13 um.

In one embodiment, a thickness of the hard coating layer may be less than or equal to about 10% of a thickness of the upper protective film.

In one embodiment, an elastic modulus of the hard coating layer may be less than or equal to about 10 GPa.

In one embodiment, a hardness of the hard coating layer may be in a range of about 40 KPa·mm³ to about 170 KPa·mm³.

An electronic device according to an embodiment of the disclosure may include a processor that applies driving signals and a display device manufactured by a method including forming a base layer on a lower protective film, forming a hard coating layer on the base layer, forming a refractive layer having a refractive index of less than or equal to about 1.4 on the hard coating layer, and cutting an upper protective film including the base layer, the hard coating layer, and the refractive layer and the lower protective film with a laser.

A method for manufacturing a display device according to an embodiment of the disclosure may include forming a base layer on a lower protective film, forming a hard coating layer on the base layer, forming a refractive layer having a refractive index of less than or equal to about 1.4 on the hard coating layer, and cutting an upper protective film including the base layer, the hard coating layer, and the refractive layer and the lower protective film with a laser.

Therefore, by forming a refractive layer having a refractive index of less than or equal to about 1.4 on the top of the protective film using a vacuum deposition method, the elastic strain against external impact, etc. and the reflectance against external light may be reduced. In addition, by cutting the protective film with a laser rather than a knife, the elastic strain value may be further increased compared to cutting with a knife. Accordingly, a user using a foldable display device may secure stability and reliability when using a device according to an embodiment of the disclosure.

### BRIEF DESCRIPTION OF THE DRAWINGS

The accompanying drawings, which are included to provide a further understanding of the disclosure and are incorporated in and constitute a part of this specification, illustrate embodiments of the disclosure together with the description.

FIG. 1 is a perspective view of an electronic device according to an embodiment of the disclosure.

FIG. 2 is a perspective view showing a folded state of the electronic device shown in FIG. 1.

FIG. 3 is an exploded perspective view of the electronic device shown in FIG. 1.

FIG. 4 is a schematic cross-sectional view of a display device shown in FIG. 3 taken along line I-I′.

FIGS. 5, 6, 7, 8, and 9 are views for explaining a manufacturing method of an upper protective film of FIG. 4.

FIGS. 10 and 11 are views for explaining a manufacturing method of the display device of FIG. 4.

FIG. 12 is a block-diagram for showing an electronic device according to an embodiment of the disclosure.

### DETAILED DESCRIPTION OF THE EMBODIMENTS

Illustrative, non-limiting embodiments will be more clearly understood from the following detailed description in conjunction with the accompanying drawings.

In this specification, a plane may be defined by a first direction D1 and a second direction D2 that intersects the first direction D1. For example, the second direction D2 may be perpendicular to the first direction D1. A third direction D3 may be the normal direction of the plane. For example, the third direction D3 may be perpendicular to the plane formed by the first direction D1 and the second direction D2.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Also, when an element is referred to as being “in contact” or “contacted” or the like to another element, the element may be in “electrical contact” or in “physical contact” with another element; or in “indirect contact” or in “direct contact” with another element.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

In the specification and the claims, the phrase “at least one of” is intended to include the meaning of “at least one selected from the group of” for the purpose of its meaning and interpretation. For example, “at least one of A and B” may be understood to mean “A, B, or A and B.” In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

Unless otherwise defined or implied herein, all terms (including technical and scientific terms) used have the same meaning as commonly understood by those skilled in the art to which this disclosure pertains. It will be further understood that terms, such as those defined in commonly used dictionaries, should be interpreted as having a meaning that is consistent with their meaning in the context of the relevant art and should not be interpreted in an ideal or excessively formal sense unless clearly defined in the specification.

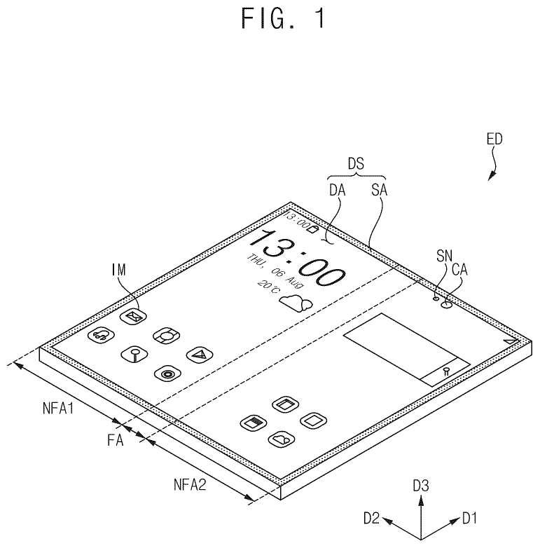

FIG. 1 is a perspective view of an electronic device according to an embodiment of the disclosure.

Referring to FIG. 1, an electronic device ED according to an embodiment of the disclosure may have a rectangular shape in a plan view including long sides extending in the first direction D1 and short sides extending in the second direction D2 intersecting the first direction D1. However, the disclosure is not limited thereto, and the electronic device ED may have various shapes such as square, circular, and polygonal. The electronic device ED may be a flexible display device.

The electronic device ED may include a folding area FA and multiple non-folding areas NFA1 and NFA2 adjacent to the folding area FA. The non-folding areas NFA1 and NFA2 may include a first non-folding area NFA1 and a second non-folding area NFA2. The folding area FA may be disposed between the first non-folding area NFA1 and the second non-folding area NFA2. The folding area FA, the first non-folding area NFA1, and the second non-folding area NFA2 may be arranged in the second direction D2.

An upper surface of the electronic device ED may be defined as a display surface DS, and the display surface DS may include a plane defined by the first direction D1 and the second direction D2. Images IM generated by the electronic device ED may be provided to the user through the display surface DS.

The display surface DS may include a display area DA and a peripheral area SA adjacent to the display area DA. The display area DA may display an image, and the peripheral area SA may not display an image. The peripheral area SA may surround the display area DA in a plan view and define a border of the electronic device ED printed in a color.

The electronic device ED may include at least one sensor SN and at least one camera CA. The sensor SN and the camera CA may be adjacent to an edge of the electronic device ED. The sensor SN and the camera CA may be disposed in the display area DA adjacent to the peripheral area SA. Although the sensor SN and the camera CA are shown as being disposed in the second non-folding area NFA2, the disclosure is not limited thereto, and in another embodiment, the sensor SN and the camera CA may be disposed in the first non-folding area NFA1.

Light may be transmitted through portions of the electronic device ED on which the sensor SN and the camera CA are disposed to be provided to the sensor SN and the camera CA. For example, the sensor SN may be a proximity light sensor, but a type of sensor SN is not limited thereto. The camera CA may capture an external image. The sensor SN and the camera CA may be provided in plural.

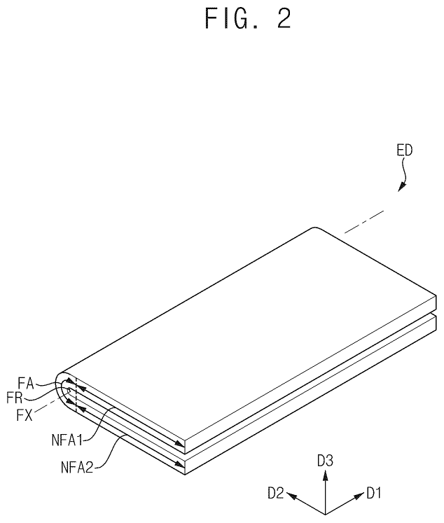

FIG. 2 is a perspective view showing a folded state of the electronic device shown in FIG. 1.

Referring to FIG. 2, the electronic device ED may be a foldable electronic device that can be folded or unfolded. For example, the folding area FA may be bent with respect to a folding axis FX parallel to the first direction D1, such that the electronic device ED may be folded. The folding axis FX may be defined as an axis parallel to the long side of the electronic device ED.

In case that the electronic device ED is folded, the first non-folding area NFA1 and the second non-folding area NFA2 may face each other, and the electronic device ED may be in-folded so that the display surface DS may not be exposed to the outside. However, the disclosure is not limited thereto. For example, the electronic device ED may be out-folded around the folding axis FX so that the display surface DS may be exposed to the outside.

As shown in FIG. 2, a distance between the first non-folding area NFA1 and the second non-folding area NFA2 may be about twice a radius of curvature FR.

In one embodiment, the radius of curvature FR of the electronic device ED may be in a range of about 0.5 mm to about 2 mm. For example, the radius of curvature FR may be in a range of about 0.5 mm to about 1.5 mm. However, the disclosure is not limited thereto.

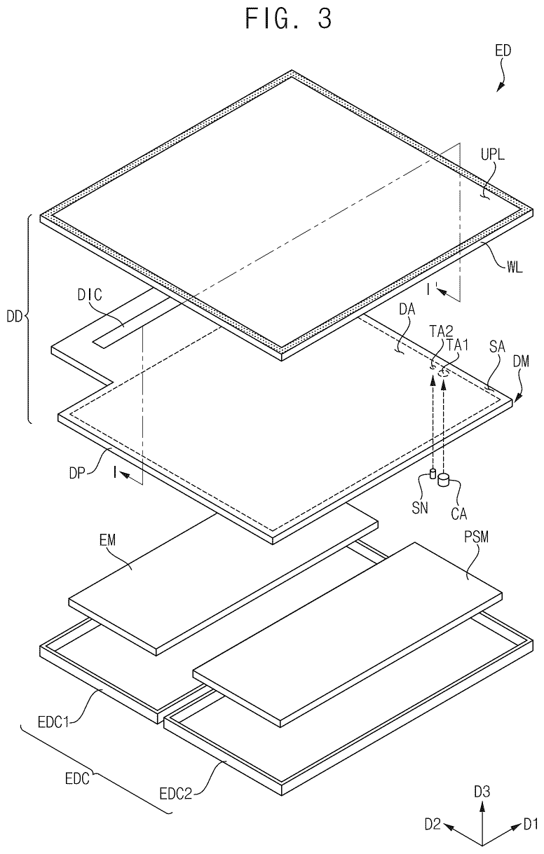

FIG. 3 is an exploded perspective view of the electronic device shown in FIG. 1.

Referring to FIG. 3, the electronic device ED may include a display device DD, an electronic module EM, a power module PSM, and a case EDC. Although not separately shown, the electronic device ED may further include a mechanical structure (e.g., a hinge) for controlling a folding operation of the display device DD.

The display device DD may generate images and detect external inputs. The display device DD may include a window layer WL and a display module DM.

The window layer WL may provide a front surface of the electronic device ED. The window layer WL may be disposed on the display module DM to protect the display module DM. Specifically, the window layer WL may protect the electronic device ED from external impacts and scratches by attaching an upper protective film UPL to an upper surface of the window layer WL. The window layer WL may transmit a light generated in the display module DM and provide it to a user.

The display module DM may include a display panel DP. Although only the display panel DP is shown in FIG. 3 among stacked structures of the display module DM, the display module DM may further include multiple components disposed above and below the display panel DP.

The display panel DP may include the display area DA and the peripheral area SA respectively corresponding to the display area DA and the peripheral area SA of the electronic device ED.

A first transparent area TA1 and a second transparent area TA2 may be defined in the display panel DP. The first transmission area TA1 and the second transmission area TA2 may have a higher light transmittance than adjacent areas. For example, the camera CA may be disposed under the first transmission area TA1, and the sensor SN may be disposed under the second transmission area TA2. Light transmitted through the first and second transmission areas TA1 and TA2 may be provided to the camera CA and the sensor SN.

The display module DM may include a data driver DIC disposed on the peripheral area SA of the display panel DP. The data driver DIC may be manufactured in a form of an integrated circuit chip and mounted on the peripheral area SA. However, the disclosure is not limited thereto, and in another embodiment, the data driver DIC may be mounted on a flexible circuit board connected to the display panel DP.

The electronic module EM and the power module PSM may be disposed below the display device DD. Although not shown, the electronic module EM and the power module PSM may be connected to each other through a separate flexible circuit board. The electronic module EM may control an operation of the display device DD. The power module PSM may supply power to the electronic module EM.

The case EDC may accommodate the display device DD, the electronic module EM, and the power module PSM. The case EDC may protect the display device DD, the electronic module EM, and the power module PSM. The case EDC may include first and second cases EDC1 and EDC2 to fold the display device DD. The first and second cases EDC1 and EDC2 may extend in the first direction D1 and be arranged in the second direction D2.

Although not shown, the electronic device ED may further include a hinge structure for connecting the first and second cases EDC1 and EDC2.

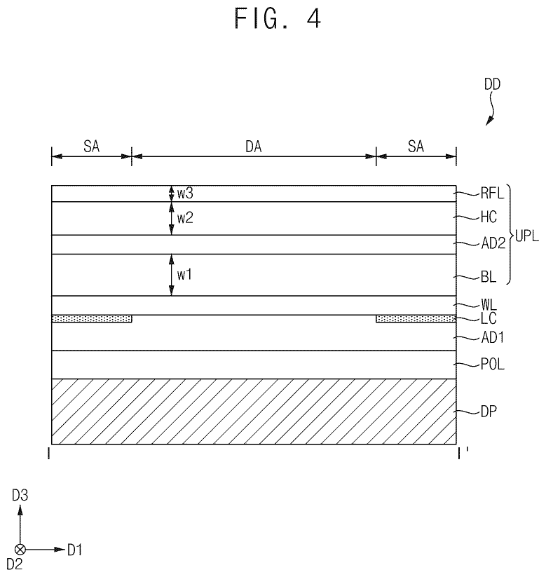

FIG. 4 is a schematic cross-sectional view of the display device shown in FIG. 3 taken along line I-I′.

Referring to FIG. 4, the display device DD may include the display panel DP, a polarizing layer POL, a first adhesive layer AD1, a light blocking layer LC, the window layer WL, and the upper protective film UPL.

The display panel DP may be disposed at the bottom of the display device DD. The display panel DP may include a display area DA that displays an image and a peripheral area SA adjacent to the display area DA.

The polarization layer POL may be disposed on the display panel DP. The polarization layer POL may change the optical axis of light emitted from the display panel DP. The polarization layer POL and the display panel DP may have substantially a same size in a plan view. The polarizing layer POL may be a single layer or multiple layers including a polarizing film and a retardation film. However, the disclosure is not limited thereto.

The first adhesive layer AD1 may be disposed on the polarizing layer POL. The first adhesive layer AD1 may include a photo-curable resin. In case that a photoinitiator included in a small amount in the resin is exposed to light, a photopolymerization reaction may be initiated, and the monomer and oligomer, which are main components of the resin, may instantly form a polymer and harden. The polarization layer POL and the window layer WL may be attached through the first adhesive layer AD1.

The light blocking layer LC may be disposed on at least a portion of the first adhesive layer AD1. The light blocking layer LC may be disposed in the peripheral area SA. The light blocking layer LC may prevent a driver that drives the display panel DP from being visible to the outside. The light blocking layer LC may be composed of a single layer. In another embodiment, the light blocking layer LC may include multiple layers having a same thickness or different thicknesses. The light blocking layer LC may be omitted.

The window layer WL may be disposed on the first adhesive layer AD1.

The window layer WL may include a transparent material, for example, glass or plastic. For example, the window layer WL may include ultra-thin glass or a transparent polyimide film with a width of less than or equal to about 0.3 mm in the third direction D3. For example, the window layer WL may be composed of a single layer. In another embodiment, the window layer WL may include multiple layers. However, the disclosure is not limited thereto.

The upper protective film UPL may be disposed on the window layer WL. The upper protective film UPL may include a base layer BL, a second adhesive layer AD2, a hard coating layer HC, and a refractive layer RFL.

In one embodiment, the upper protective film UPL may have a reflectance of less than or equal to about 2% for light having a wavelength of about 550 nm. For example, the upper protective film UPL may have a reflectance in a range of about 0.5% to about 2% for light having a wavelength of about 550 nm. For example, the upper protective film UPL may have a reflectance in a range of about 0.5% to about 1.5% for light having a wavelength of about 550 nm. If the reflectance is higher than the above range, visibility may be reduced due to reflection of external light. However, the disclosure is not limited thereto.

In one embodiment, an elastic strain of the upper protective film UPL may be in a range of about 7% to about 30%. For example, the elastic strain of the upper protective film UPL may be in a range of about 8% to about 30%. For example, the elastic strain may be in a range of about 8% to about 25%. If the elastic strain of the upper protective film UPL is less than the above range, cracks, etc. may occur. However, the disclosure is not limited thereto.

The base layer BL may include a plastic. For example, the base layer BL may include at least one of polyethylene terephthalate (PET), polyethylene naphthalate (PEN), polyether sulfone (PES), polyimide (PI), polyacrylate (PAR), polycarbonate (PC), polymethyl methacrylate (PMMA), cycloolefin copolymer (COC), a polyether block amide (PEBA) resin, etc. These may be used alone or in combination with each other. However, the disclosure is not limited thereto.

In one embodiment, a first thickness w1 of the base layer BL in the third direction D3 may be in a range of about 30 μm to about 150 μm. For example, the first thickness w1 of the base layer BL in the third direction D3 may be in a range of about 50 μm to about 120 μm. However, the disclosure is not limited thereto.

The second adhesive layer AD2 may be disposed on the base layer BL. The second adhesive layer AD2 and the first adhesive layer AD1 may have substantially a same function and a same material. Accordingly, the base layer BL and the hard coating layer HC may be attached to each other through the second adhesive layer AD2.

The hard coating layer HC may be disposed on the second adhesive layer AD2. For example, the hard coating layer HC may be attached to the base layer BL through the second adhesive layer AD2. The hard coating layer HC may protect a surface of the window layer WL from physical and chemical damage, and improve mechanical properties of the window layer WL. The hard coating layer HC may include at least one of polyimide, polycarbonate, polyethersulfone, polyethylene naphthalate, polyphenylene sulfide, liquid crystal polymer (LCP), polymethyl methacrylate, acrylic polymer, epoxy polymer, etc. These may be used alone or in combination with each other. However, the disclosure is not limited thereto.

In one embodiment, a second thickness w2 of the hard coating layer HC in the third direction D3 may be in a range of about 3 μm to about 13 μm. For example, the second thickness w2 of the hard coating layer HC in the third direction D3 may be in a range of about 5 μm to about 13 μm. For example, the second thickness w2 of the hard coating layer HC in the third direction D3 may be in a range of about 5 μm to about 8 um. However, the disclosure is not limited thereto.

In one embodiment, an elastic modulus of the hard coating layer HC may be less than or equal to about 10 GPa. For example, the elastic modulus of the hard coating layer HC may be in a range of about 2 GPa to about 5 GPa. For example, the elastic modulus of the hard coating layer HC may be in a range of about 2.5 GPa to about 4.5 GPa. If the elastic modulus of the hard coating layer HC is less than the range described above, the upper protective film UPL may be readily deformed. Conversely, if the elastic modulus of the hard coating layer HC is greater than the range described above, cracks may readily occur in the upper protective film UPL. However, the disclosure is not limited thereto.

In one embodiment, a hardness of the hard coating layer HC may be in a range of about 40 kpa·mm³ to about 170 kpa·mm³. For example, the hardness of the hard coating layer HC may be in a range of about 60 kpa·mm³ to about 150 kpa·mm³. However, the disclosure is not limited thereto.

The refractive layer RFL may be disposed on the hard coating layer HC. The refractive layer RFL may have a low reflectance, the refractive layer RFL may not increase in reflectance or may minimize an increase in reflectance even at high temperature or high temperature and high humidity. Accordingly, the reliability and external light blocking effect of the display device DD may be excellent.

In one embodiment, a refractive index of the refractive layer RFL may be less than or equal to about 1.5. For example, the refractive index of the refractive layer RFL may be less than or equal to about 1.4. If the refractive index of the refractive layer RFL is greater than the above range, visibility may be reduced in case that a user uses the display device DD.

In one embodiment, the refractive layer RFL may include an organic compound including difluorocarbene (—CF2) and trifluoromethyl group (—CF3). For example, the refractive layer RFL may include an organic compound having a molar ratio of CF2:CF3=2:1. For example, the refractive layer RFL may include dodecafluoroheptyl acrylate (DFHA) represented by the Formula 1 below.

For example, the refractive layer RFL may be formed by crosslinking two or more organic compounds including DFHA represented by the Formula 1 below.

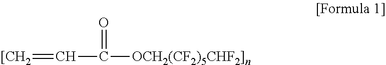

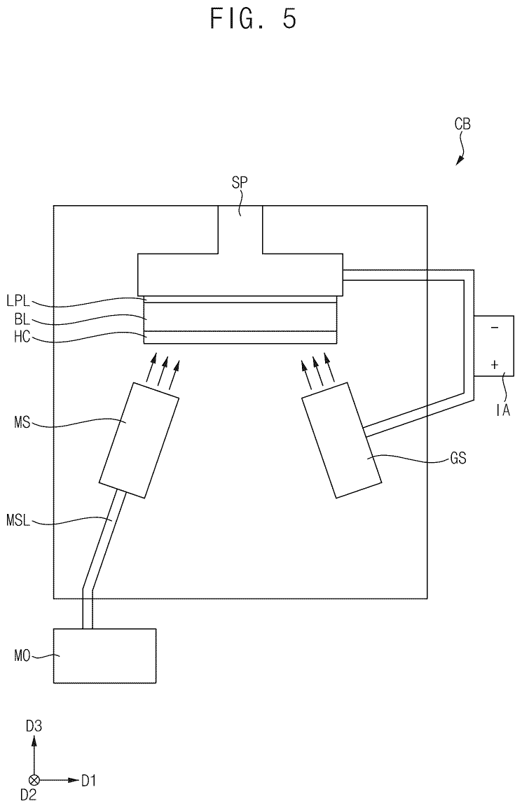

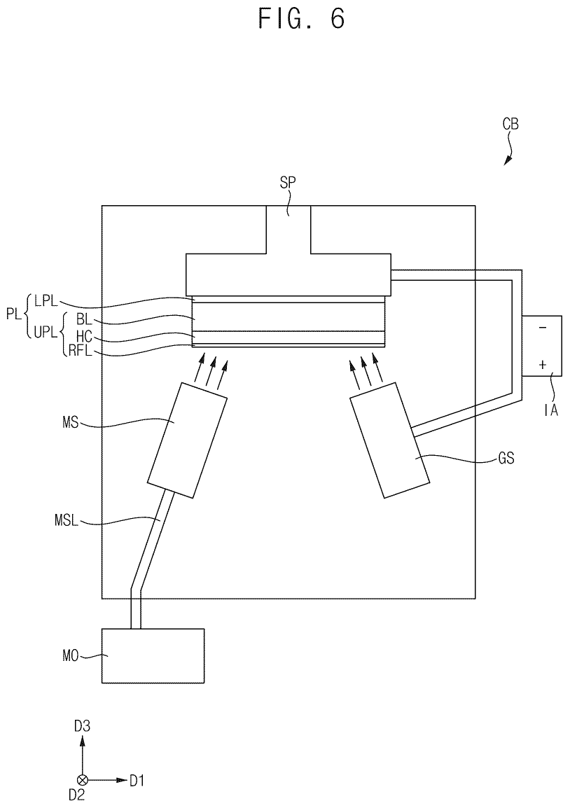

n may be one of 6, 8, 10, and 12. For example, n may be one of 8, 10 and 12. For example, n may be 8. For example, in case that n=8, the crystallinity of the refractive layer RFL may be strong, and as shown in FIGS. 5 and 6, the refractive layer RFL may be manufactured at a voltage lower than 500V during the manufacturing process using ion acceleration voltage.

With respect to the trifluoromethyl group (—CF3), terminals of some of the monomers of the organic compound represented by Formula 1 may be trifluoromethyl groups (—CF3), and among the monomers of the organic compound represented by Formula 1 a remaining terminal may not be a trifluoromethyl group (—CF3).

In one embodiment, a third thickness w3 of the refractive layer RFL in the third direction D3 may be in a range of about 50 nm to about 150 nm. For example, the third thickness w3 of the refractive layer RFL in the third direction D3 may be in a range of about 70 nm to about 130 nm. However, the disclosure is not limited thereto.

In one embodiment, the refractive layer RFL may be a single layer. For example, functional layers such as an anti-fingerprint layer may not be disposed on the refractive layer RFL. However, the disclosure is not limited thereto. The refractive layer RFL may include a layer in which multiple refractive layers may be alternately stacked each other.

In one embodiment, the refractive layer RFL may include a crosslinking agent. For example, the crosslinking agent may include zinc diacrylate. In another embodiment, the crosslinking agent may include dicumyl peroxide, benzoyl peroxide, lauryl peroxide, t-butyl cumyl peroxide, di(t-butylperoxyisopropyl)benzene, 2,5-dimethyl-2,5-di(t-butyl peroxy) hexane, di-t-butyl peroxide, 1,1-bis(t-butylperoxy)-3,3,5-trimethyl cyclohexane, 1,1-bis(t-butylperoxide) Oxy) cyclohexane, t-butylperoxy maleic acid, t-butylperoxy-3,3,5-trimethylhexanoate, cyclohexanone peroxide, t-butylperoxy aryl carbonate, t-butylperoxy iso propyl carbonate, 2,5-dimethyl-2,5-di(benzoylperoxy) hexane, 2,2-bis(t-butylperoxy) octane, t-butylperoxy acetate, 2,2-bis(t-Butylperoxy) butane, t-butylperoxybenzoate, n-butyl-4,4-bis(t-butylperoxybutylperoxy) valerate, di-t-butylperoxy isophthalate, methyl ethyl ketone oxide, α,α′-bis(t-butylperoxy-m-isopropyl)benzene, di-isopropylbenzene hydroperoxide, di-t-butyl peroxide, 2,5-dimethyl-2, etc. These may be used alone or in combination with each other. However, the disclosure is not limited thereto.

In one embodiment, water contact angle, which is an internal angle formed between the refractive layer RFL and water, may be greater than or equal to about 90 degrees. For example, the water contact angle of the refractive layer RFL may be in a range of about 100 degrees to about 125 degrees. Accordingly, the refractive layer RFL may have resistance to contamination and may perform an anti-fingerprint function. In other words, if the refractive layer has a water contact angle lower than the above range, it may be vulnerable to contamination or the anti-fingerprint function may be deteriorated. However, the disclosure is not limited thereto.

Below, effects of the disclosure according to Comparative Examples and Examples will be described.

### Example 1, Comparative Example 1 and Comparative Example 2

Table 1 below shows that in the upper protective film UPL including a refractive layer RFL according to Example 1, the refractive layer RFL including DFHA was formed to a thickness of 90 nm. Table 1 below shows the upper protective film including a refractive layer according to Comparative Examples 1 and 2, where the refractive layer including ZrOₓ, SiO, Nb₂O₅, and SiO₂ was formed.

Specifically, referring to Table 1 below, Example 1 includes an upper protective film UPL including a base layer (thickness: 65 um) including polyethylene terephthalate (PET), a hard coating layer (thickness: 5 um) disposed on the base layer, and refractive layer (thickness: 90 nm) including disposed on the hard coating layer and including a DFHA.

Comparative Example 1 includes an upper protective film including a base layer (thickness: 50 um) including polyethylene terephthalate (PET), a hard coating layer (thickness: 5 um) disposed on the base layer, and a refractive layer disposed on the hard coating layer and including ZrOx (thickness: 110 nm) and SiO (thickness: 80-90 nm).

Comparative Example 2 includes an upper protective film including a base layer (thickness: 50 um) including polyethylene terephthalate (PET), a hard coating layer (thickness: 5 um) disposed on the base layer, and a refractive layer disposed on the hard coating layer and including Nb2O5 (thickness: 11 nm), SiO2 (thickness: 25 nm), Nb2O5 (thickness: 105 nm), and SiO2 (thickness: 68 nm).

TABLE 1

| | Comparative | Comparative | |
|---|---|---|---|
| | Example 1 | Example 2 | Example 1 |
| base layer | PET (50 um)/HC | PET (50 um)/HC | PET (65 um)/HC |
| and hard | (5 um) | (5 um) | (5 um) |
| coating layer | | | |
| refractive layer | ZrOₓ (110 nm)/ | Nb₂O₅ (11 nm)/ | DFHA (90 nm) |
| | SiO (80~90 nm) | SiO₂ (25 nm)/ | |
| | | Nb2O₅ (105 nm)/ | |
| | | SiO₂ (68 nm) | |

Table 2 below is a table showing an elastic strain and reflectance of the upper protective films formed according to Example 1, Comparative Example 1, and Comparative Example 2 for light with a wavelength of about 550 nm. An effect of the upper protective film UPL described in the disclosure may be confirmed through Table 2 below.

Specifically, referring to Table 2 below, it can be confirmed that in Comparative Example 1, the elastic strain of the upper protective film was 4.5% and the reflectance for light with a wavelength of about 550 nm was 1.33%.

In Comparative Example 2, it can be confirmed that the elastic strain of the upper protective film was 2% and the reflectance for light with a wavelength of about 550 nm was 0.25%.

On the other hand, in Example 1, it can be confirmed that the elastic strain of the upper protective film was 8.2% and the reflectance for light with a wavelength of about 550 nm was 1.35%.

TABLE 2

| | Comparative | Comparative | |
|---|---|---|---|
| | Example 1 | Example 2 | Example 1 |
| Elastic strain (%) | 4.5 | 2 | 8.2 |
| reflectance (%) | 1.33 | 0.25 | 1.35 |
| (550 nm) | | | |

According to the above experiment, it can be confirmed that the elastic strain of the upper protective film including DFHA and including the refractive layer formed to a thickness of 90 nm is greater than the elastic strain of Comparative Examples 1 and 2, and the reflectance of light having a wavelength of about 550 nm is also measured within 2%.

FIGS. 5, 6, 7, 8, and 9 are views for explaining a manufacturing method of the upper protective film of FIG. 4. In particular, FIGS. 5 and 6 are schematic cross-sectional views for explaining a method for forming a refractive layer in the upper protective film of FIG. 4.

Referring to FIGS. 5 and 6, a vacuum deposition apparatus may include a chamber CB, a support part SP, an ion accelerator IA, a gas supply part GS, a monomer storage portion MO, a monomer supply line MSL, and a monomer supply portion MS.

The chamber CB may protect the protective film PL by providing a sealed environment from the outside, and may provide a space in which the protective film PL is stacked. For example, the chamber CB may be maintained in a vacuum pressure (e.g., about 10 Torr to about 200 Torr) that is lower than a normal pressure (e.g., about 1 atmosphere or about 760 Torr). For example, a vacuum deposition polymerization reaction may be performed in the chamber CB. However, the disclosure is not limited thereto.

The support part SP may be disposed in the chamber CB. The support part SP may provide a space where the protective film PL may be disposed. The support part SP may be an electrostatic chuck that holds the protective film PL using electrostatic force, or a device that supports the protective film PL in a manner such as mechanical clamping.

For example, a lower protective film LPL, the base layer BL, and the hard coating layer HC may be sequentially stacked on the support part SP. Thereafter, the refractive layer RFL may be formed on the hard coating layer HC. For example, the refractive layer RFL having a refractive index of less than or equal to about 1.4 may be formed on the hard coating layer HC. The base layer BL, the hard coating layer HC, and the refractive layer RFL sequentially stacked on the lower protective film LPL may constitute the upper protective film UPL. As will be described below, before the upper protective film UPL is attached to the window layer WL of FIG. 4, the lower protective film LPL may be separated from the upper protective film UPL and removed.

The gas supply portion GS may supply gas into the chamber CB. The gas may include an inert gas. For example, the gas may include helium, neon, argon, etc. However, the disclosure is not limited thereto. The gas may be used in combination with oxygen or the like as needed.

The ion accelerator IA may accelerate the gases provided to the chamber CB. For example, a bias voltage may be applied to the hard coating layer HC to allow the gases to collide with the hard coating layer HC.

In one embodiment, the dodecafluoroheptyl acrylate may be cross-linked on the hard coating layer HC by the ion accelerator IA. For example, the gas accelerated by the ion accelerator IA and the dodecafluoroheptyl acrylate organic compound may cross-link on the hard coating layer HC due to impact.

During forming of the refractive layer RFL by the ion accelerator IA, the chamber CB may remain dry without moisture. Accordingly, the refractive layer RFL may be formed in a dry state by vacuum deposition.

In one embodiment, an ion acceleration voltage of the ion accelerator IA may be less than or equal to about 500 V. For example, the ion acceleration voltage of the ion accelerator IA may be in a range of about 100 V to about 500 V. In case that the ion acceleration voltage of the ion accelerator IA exceeds about 500 V, water repellency of the protective film PL may be reduced. In case that the ion acceleration voltage of the ion accelerator IA is less than about 100 V, an adhesion of the protective film PL may decrease. However, the disclosure is not limited thereto.

The monomer storage portion MO, the monomer supply line MSL, and the monomer supply portion MS may provide monomers on the hard coating layer HC to form the protective film PL that may be the object. The monomer may be polymerized on the hard coating layer HC to form the refractive layer RFL. For example, the monomer storage portion MO may include the monomer, and the monomer may move along the monomer supply line MSL and may be provided into the chamber CB through the monomer supply portion MS.

In one embodiment, the lower protective film LPL, the base layer BL, and the hard coating layer HC may be formed on the support part SP, and the gas provided from the gas supply portion GS may be ion-accelerated on the hard coating layer HC to be polymerized on the hard coating layer HC together with the monomer. The gas may form the refractive layer RFL by applying an impact on the hard coating layer HC together with the monomer. For example, the ion-accelerated gas may facilitate polymerization in case that the monomer is formed on the hard coating layer HC.

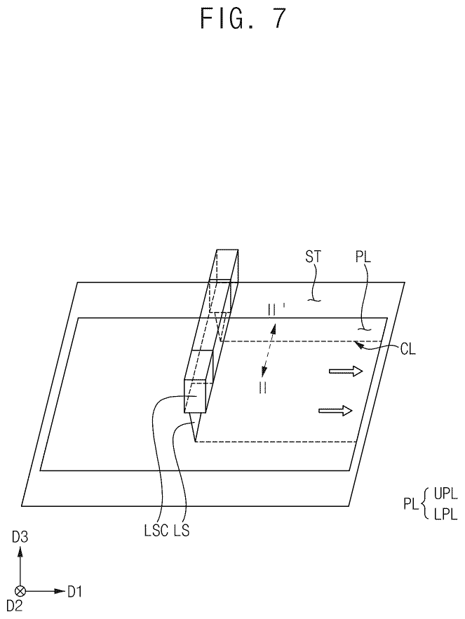

FIG. 7 is a schematic perspective view showing an embodiment of laser cutting a protective film formed through the manufacturing method of FIG. 6.

Referring to FIG. 7, the protective film PL may be disposed and moved on a stage ST. For example, as the stage ST moves in a direction, the protective film PL disposed on the stage ST may move in the direction. For example, the protective film PL may be disposed on the stage ST and move in the first direction D1.

The protective film PL may move in the direction, and the protective film PL may be cut by a laser LS irradiated by a laser cutter LSC disposed on the stage ST. For example, in case that the stage ST moves in the first direction D1, a cutting line CL may be formed by the laser LS irradiated from the laser cutter LSC on the protective film PL.

In one embodiment, a moving speed of the stage ST in the first direction D1 may be in a range of about 10 m/min to about 50 m/min. For example, the moving speed of the stage ST in the first direction D1 may be in a range of about 10 m/min to about 30 m/min. If the moving speed is less than about 10 m/min, productivity may decrease. However, the disclosure is not limited thereto.

As shown in FIG. 7, the elastic strain of the protective film PL may be increased by cutting the protective film PL with the laser LS rather than with a knife. By cutting the protective film with a laser LS rather than the knife, the elastic strain value may be further increased compared to cutting with a knife. Accordingly, a user using a foldable display device may secure stability and reliability.

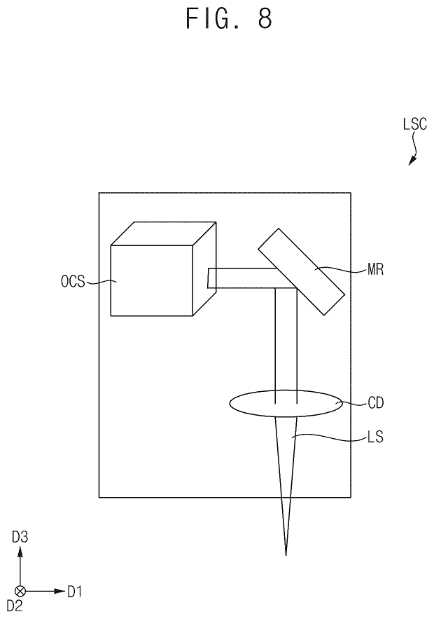

FIG. 8 is a schematic diagram showing the laser cutter of FIG. 7.

Referring to FIGS. 7 and 8, the laser cutter LSC may include an oscillator OCS, a mirror MR, and a lens CD.

In one embodiment, the laser LS oscillated from the oscillator OCS may be a CO₂ laser. The laser LS may be a solid-state laser including a YAG laser, a sapphire laser, or a gas laser including a He—Ne laser, an Ar+ laser, and an excimer laser. However, the disclosure is not limited thereto.

The oscillator OCS may oscillate the laser LS. In one embodiment, an output of the oscillator OCS may be in a range of about 5 watts to about 100 watts. For example, the output of the oscillator OCS may be in a range of about 10 watts to about 50 watts. However, the disclosure is not limited thereto.

In one embodiment, a wavelength of the laser LS may be in a range of about 5 um to about 15 um. For example, the wavelength of the laser LS may be in a range of about 7 um to about 12 um. In case that the wavelength of the laser LS is less than the above-described range, thermal damage may occur to the protective film PL, and in case that the wavelength of the laser LS is greater than the above-described range, the cutting speed of the protective film PL may be slowed, thereby lowering productivity.

In one embodiment, a diameter of the laser LS may be in a range of about 0.05 mm to about 0.2 mm. For example, the diameter of the laser LS may be in a range of about 0.05 mm to about 0.1 mm. In case that the diameter of the laser LS is less than the above-described range, the cutting speed of the protective film PL may be slowed, and in case that the diameter of the laser LS is greater than the above-described range, a lot of by-products may be generated in case that the protective film PL is cut. However, the disclosure is not limited thereto.

The laser LS emitted from the oscillator OCS may be reflected by the mirror MR, condensed by the lens CD, and irradiated to the protective film PL.

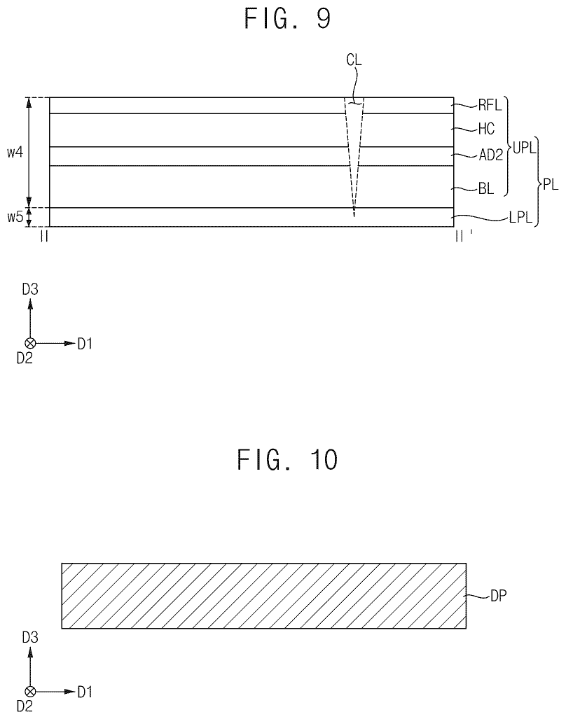

FIG. 9 is a schematic cross-sectional view showing the protective film taken along line II-II′ of FIG. 7.

Referring to FIGS. 7, 8, and 9, the protective film PL may include a cutting line CL on its cross-section by laser cutting, as shown in FIG. 7. The cutting line CL may be an area where an entire upper protective film UPL is cut in a cross-section in the third direction D3. The cutting line CL may be an area where a portion of the lower protective film LPL is cut on a cross-section in the third direction D3.

In one embodiment, the lower protective film LPL of the protective film PL may be cut in a range of about 10% or to about 70% of the thickness of the lower protective film LPL by the laser LS on a cross-section. For example, the lower protective film LPL of the protective film PL may be cut in a range of about 30% to about 70% of the thickness of the lower protective film LPL by the laser LS on a cross-section. As a portion of the lower protective film LPL is removed by the laser LS, separation from the upper protective film UPL may be facilitated. For example, the lower protective film LPL may be separated and removed from the upper protective film UPL after laser cutting. However, the disclosure is not limited thereto.

In one embodiment, the lower protective film LPL may include a plastic. For example, the lower protective film LPL may include at least one of polyethylene terephthalate (PET), polyethylene naphthalate (PEN), polyether sulfone (PES), polyimide (PI), polyacrylate (PAR), polycarbonate (PC), polymethyl methacrylate (PMMA), cycloolefin copolymer (COC), a polyether block amide (PEBA) resin, etc. These may be used alone or in combination with each other. However, the disclosure is not limited thereto.

In one embodiment, the thickness of the lower protective film LPL may be in a range of about 50 um to about 150 um. For example, the thickness of the lower protective film LPL may be in a range of about 70 um to about 120 um. However, the disclosure is not limited thereto.

Referring to FIGS. 7, 8, and 9, the upper protective film UPL and the lower protective film LPL may be cut by the laser cutter LSC. For example, a cutting line CL may be formed on the upper protective film UPL and the lower protective film LPL cut by the laser cutter LSC. For example, a region that is completely cut in the third direction D3 in cross-section by the laser cutter LSC may be defined in the upper protective film UPL. In contrast, a region partially cut in the third direction D3 in the cross-section by the laser cutter LSC may be defined in the lower protective film LPL.

In one embodiment, about 10% or more and about 90% or less of the thickness of the lower film LPL in the third direction D3 may be cut by the laser LS. For example, about 10% or more and about 70% or less of the thickness of the lower film LPL in the third direction D3 may be cut by the laser LS. However, the disclosure is not limited thereto.

In one embodiment, a fifth thickness w5 of the lower protective film LPL may be less than or equal to about 20% of a fourth thickness w4 of the upper protective film UPL. For example, the thickness w5 of the lower protective film LPL may be less than or equal to about 10% of the thickness w4 of the upper protective film UPL. However, the disclosure is not limited thereto.

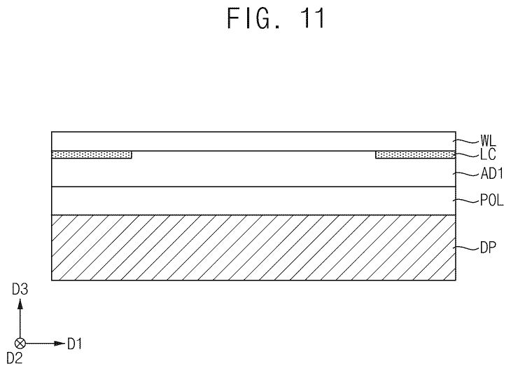

FIGS. 10 and 11 are views for explaining a manufacturing method of the display device of FIG. 4.

Referring to FIGS. 10 and 11, the polarization layer POL may be formed on the display panel DP. The polarization layer POL may cover the display panel DP. The polarizing layer POL may be formed as a single layer or multiple layers including a polarizing film and a retardation film. However, the disclosure is not limited thereto.

The first adhesive layer AD1 may be formed on the polarizing layer POL. The first adhesive layer AD1 may include a photo-curable resin. In case that a photoinitiator contained in a small amount in the resin is exposed to light, a photopolymerization reaction may be initiated, and the monomers and oligomers, which are the main components of the resin, may instantaneously form a polymer and harden.

The light blocking layer LC may be formed on at least a portion of the first adhesive layer AD1. The light blocking layer LC may be formed in a peripheral area (e.g., the peripheral area SA in FIG. 4).

The window layer WL may be formed on the first adhesive layer AD1. For example, the window layer WL may be attached to the polarization layer POL through the first adhesive layer AD1. The window layer WL may include a transparent material such as, for example, glass or a plastic. For example, the window layer WL may be composed of a single layer.

The upper protective film UPL of FIG. 4 may be formed according to the process performed in FIGS. 5, 6, 7, 8, and 9. For example, the upper protective film UPL of FIG. 4 formed according to FIGS. 5 and 6 may be attached to the window layer WL. As a result, the display device DD shown in FIG. 4 may be manufactured.

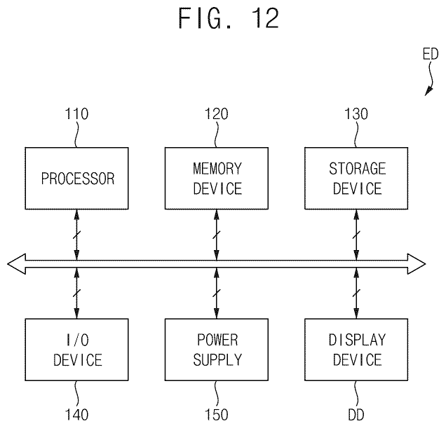

FIG. 12 is a block-diagram for showing an electronic device according to an embodiment of the disclosure.

Referring to FIGS. 1, 3, and 12, an electronic device ED may include a processor 110, a memory device 120, a storage device 130, an input/output device 140, a power supply 150, and the display device DD. The display device DD included in the electronic device ED may be the display device DD of FIG. 4. In addition, the electronic device ED may further include several ports capable of communicating with a video card, a sound card, a memory card, a USB device, etc., or communicating with other systems.

The processor 110 may perform specific calculations or tasks. In an embodiment, the processor 110 may be a microprocessor, a central processing unit, an application processor, etc. The processor 110 may be connected to other components through an address bus, a control bus, a data bus, etc. In an embodiment, the processor 110 may also be connected to an expansion bus, such as a Peripheral Component Interconnect (PCI) bus. The processor 110 may output data control signals and image data to the timing controller.

The memory device 120 may store data necessary for an operation of the electronic device ED. For example, the memory device 120 may include nonvolatile memory devices such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM), a ferroelectric random access memory (FRAM) device, and/or a volatile memory device such as a dynamic random access memory (DRAM) device, a static random access memory (SRAM) device, a mobile DRAM device, and the like.

The storage device 130 may include a solid state drive (SSD), a hard disk drive (HDD), a CD-ROM, etc. The input/output device 140 may include an input means such as a keyboard, a keypad, a touchpad, a touchscreen, a mouse, etc., and an output means such as a speaker, a printer, etc. In an embodiment, the display device DD may be included in the input/output device. The power supply 150 may supply power required for the operation of the electronic device ED. The display device may be connected to other components through the buses or other communication links.

Referring further to FIG. 1, the electronic device ED may be implemented as a smartphone. The window layer WL may cover the display device DD. For example, the window layer WL may be disposed on the display area (e.g., a display area DA of FIG. 1) of the display device DD to cover the display device DD. Accordingly, the window layer WL may protect the display area of the display device DD where the image is displayed.

A case EDC may surround the display device DD. For example, the display device DD may be accommodated in the case EDC. The case EDC may cover side and bottom of the display device DD. Accordingly, the case EDC may supplement a rigidity of the display device DD and protect the display device DD from external impact.

A functional module such as a camera module or a sensor module may be accommodated in the case EDC. Accordingly, the functional module may be electrically connected to the display device DD and perform a specific function. However, type or arrangement of the functional module according to the embodiments of the present disclosure is not necessarily limited thereto.

The disclosure may be applied to the display device and the electronic device including a same. For example, the disclosure may be applied to high-resolution smartphones, mobile phones, smart pads, smart watches, tablet PCs, vehicle navigation systems, televisions, computer monitors, laptops, etc.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A method of manufacturing a display device comprising:
forming a base layer on a lower protective film;
forming a hard coating layer on the base layer;
forming a refractive layer having a refractive index of less than or equal to about 1.4 on the hard coating layer; and
cutting an upper protective film including the base layer, the hard coating layer, and the refractive layer and the lower protective film with a laser.

2. The method of claim 1, wherein an output of an oscillator that irradiates the laser is in a range of about 5 watts to about 100 watts.

3. The method of claim 1, wherein a wavelength of the laser is in a range of about 5 um to about 15 um.

4. The method of claim 1, wherein a diameter of the laser is in a range of about 0.05 mm to about 0.2 mm.

5. The method of claim 1, further comprising:
removing the lower protective film after the cutting of the upper protective film and the lower protective film with the laser.

6. The method of claim 1, wherein in the cutting of the upper protective film and the lower protective film with the laser,
the upper protective film and the lower protective film are disposed on a stage and moved, and
a moving speed of the stage is in a range of about 10 m/min to about 50 m/min.

7. The method of claim 1, wherein the lower protective film includes a plastic.

8. The method of claim 1, wherein a thickness of the lower protective film is in a range of about 50 um to about 150 um.

9. The method of claim 1, wherein in the cutting of the upper protective film and the lower protective film with the laser, the laser cuts about 10% or more and about 70% or less of a thickness of the lower protective film.

10. The method of claim 1, wherein the refractive layer includes an organic compound including a difluorocarbene (—CF₂) and a trifluoromethyl group (—CF₃).

11. The method of claim 10, wherein a molar ratio of the difluorocarbene to the trifluoromethyl group is about 2:1.

12. The display device of claim 10, wherein the organic compound includes dodecafluoroheptyl acrylate (DFHA) represented by Formula 1: 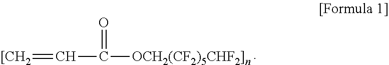
in Formula 1, n is one of 6, 8, 10, and 12.

13. The method of claim 1, wherein in the forming of the refractive layer, the refractive layer is formed by a vacuum deposition.

14. The method of claim 1, wherein the refractive layer is a single layer.

15. The method of claim 1, wherein an elastic strain of the upper protective film is in a range of about 7% to about 30%.

16. The method of claim 1, wherein a thickness of the refractive layer is in a range of about 70 nm to about 130 nm.

17. The method of claim 1, wherein a thickness of the hard coating layer is in a range of about 5 um to about 13 um.

18. The method of claim 1, wherein a thickness of the hard coating layer is less than or equal to about 10% of a thickness of the upper protective film.

19. The method of claim 1, wherein an elastic modulus of the hard coating layer is less than or equal to about 10 GPa.

20. The method of claim 1, wherein a hardness of the hard coating layer is in a range of about 40 KPa·mm³ to about 170 KPa·mm³.

21. An electronic device comprising:
a processor that applies driving signals; and
a display device manufactured by a method including:
forming a base layer on a lower protective film;
forming a hard coating layer on the base layer;
forming a refractive layer having a refractive index of less than or equal to about 1.4 on the hard coating layer; and
cutting an upper protective film including the base layer, the hard coating layer, and the refractive layer and the lower protective film with a laser.
